(19) United States
(12) Patent Application Publication
(10) Pub. No.: US 2001/0033280 A1
(43) Pub. Date: Oct. 25, 2001

(54) Three-dimensional model processing apparatus, method and program providing medium

(76) Inventors: Yuichi Abe, Tokyo (JP); Hiroyuki Segawa, Kanagawa (JP); Hiroyuki Shioya, Tokyo (JP); Nori Kazu Hiraki, Tokyo (JP)

Correspondence Address: William E. Vaughan, Bell, Boyd & Lloyd LLC, P.O. Box 1135, Chicago, IL, 60690, US

(21) Appl. No.: 09/809,263

(22) Filed: Mar. 15, 2001

(30) Foreign Application Priority Data
Mar. 15, 2000 (JP) P2000-072078

(51) Int. Cl. G06T 15/00

(52) U.S. Cl. 345/419

(57) ABSTRACT

A three-dimensional model processing apparatus is disclosed by which a three-dimensional position of a body displayed on a display unit can be recognized readily. A reference point is displayed in the proximity of a body displayed on the display unit, and a straight line produced by rotating the Z-axis by a predetermined angle around the X-axis is displayed as a straight line extending from the reference point. Further, a plane is produced by rotating the XZ plane by the predetermined angle around the X-axis, and an intersecting line between the plane and the body is displayed together with the body. The display facilitates recognition of the three-dimensional position of the body displayed on the display unit. Where the three-dimensional model processing apparatus is incorporated in a three-dimensional modeling apparatus which performs deformation or the like of a three-dimensional model using a sensor, such a reference point, a straight line extending from the reference point and an intersecting line formed from a plane including the reference point as described above are displayed together with the processing object body.

### BACKGROUND OF THE INVENTION

1. Field of the Invention

The present invention relates to a three-dimensional processing apparatus and a three-dimensional processing method as well as a program providing medium for displaying a three-dimensional position of a body.

2. Description of the Prior Art

In computer graphics wherein a three-dimensional image is displayed on a display unit, a body in a three-dimensional space as a display object is mapped in a two-dimensional space and a result of the mapping is displayed on a display unit such as a cathode ray tube (CRT). Where a number of bodies are present in a three-dimensional space, it is difficult to recognize a positional relationship of the bodies, particularly a positional relationship of the bodies in the depthwise direction of the display unit from the display of the display unit.

In order to display a number of different bodies which overlap with each other on a display screen, a technique has been conventionally employed wherein a body positioned forwardly of, or nearer to, the visual point is displayed on the display unit while a portion of another body positioned rearwardly of, or farther than, the body which overlaps with the nearer body is not displayed. This represents a difference in distance from the visual point between the display bodies; that is, a positional relationship of the display bodies in the depthwise direction. Another technique has been conventionally adopted wherein a number of images from different visual points are displayed simultaneously on a display unit; for example, an image viewed in a direction from a visual point and another image viewed in another direction different by 90 degrees from that of the first image. This could be, for example, an image viewed from above displayed simultaneously on a display unit to allow a positional relationship of the display bodies to be recognized.

However, in the image displaying method wherein an overlapping portion is not displayed as described above, where two different bodies do not overlap with each other, it cannot be discriminated which one of the bodies is positioned nearer or farther. Although yet another technique is available wherein the farther body is displayed in a reduced size to allow a positional relationship to be recognized through a perspective representation, where the size of a body cannot be recognized in advance, it cannot be discriminated, for example, whether the body is displayed in a reduced size through a perspective representation or is originally small in size and the positional relationship of the body cannot be recognized. Further, even where a number of bodies overlap with each other, it cannot be recognized by what distance the bodies are spaced from each other.

Further, with the method wherein a number of images from different visual points are displayed, it is difficult to simultaneously watch all images, and the positional relationship of the bodies cannot be recognized at a glance at the display of the display unit.

### SUMMARY OF THE INVENTION

It is, therefore, an object of the present invention to provide a three-dimensional model processing apparatus and a three-dimensional model processing method, as well as a program providing medium by which a positional relationship of a number of bodies which do not overlap with each other in an image can be recognized readily.

In order to attain the object described above, according to the present invention, an auxiliary line is displayed on an image display unit to make it possible to recognize a three-dimensional positional relationship of a displayed body readily from a two-dimensional image displayed on the image display unit.

In particular, in an embodiment of the present invention, there is provided a three-dimensional model processing apparatus for causing a display unit to display a body based on position data of the body in a three-dimensional space, including a setting part for setting a reference point in the proximity of the body in the three-dimensional space displayed on the display unit, and a display control part for producing a straight line in the three-dimensional space which passes the reference point and for controlling the display unit to display the straight line together with the body.

Preferably, the display control part further produces an intersecting line between a plane in the three-dimensional space which includes the reference point and the display object body and controls the display unit to display the intersecting line together with the body.

The display control part may further control the display unit to display a plane in the three-dimensional space which includes the reference point.

Preferably, the straight line which passes the reference point is a straight line parallel to a straight line which is produced, where a display plane of the display unit is an XY plane and a direction perpendicular to the display plane is a Z-axis, by rotating the Z-axis by an angle of α degrees around the X-axis where −90<α<90 and α≠0.

Preferably, the plane which includes the reference point is a plane parallel to a plane which is produced, where a display plane of the display unit is an XY plane and a direction perpendicular to the display plane is a Z-axis, by rotating the XZ plane by an angle of α degrees around the X-axis where −90<α<90 and α≠0.

The plane which includes the reference point may be a plane which is, where a display plane of the display unit is an XY plane and a direction perpendicular to the display plane is a Z-axis, a plane parallel to the YZ plane.

Preferably, the display control part further produces a number of intersecting lines between a number of planes in the three-dimensional space which include the reference point and the display object body and controls the display unit to display the intersecting lines together with the body.

Graduations may be indicated in a spaced relationship by a predetermined distance from each other on the straight line.

Grating lines may be indicated in a spaced relationship by a predetermined distance from each other on the plane.

Preferably, the display control part controls the display unit to display a plane, which is parallel to a plane produced, where a display plane of the display unit is an XY plane and a direction perpendicular to the display plane is a Z-axis, by rotating the XZ plane by an angle of α degrees around the X-axis where −90<α<90 and α≠0, at a position at which the plane does not intersect with the body and display a projection image of the body, the reference point and the straight line on the plane.

According to another embodiment of the present invention, there is provided a three-dimensional model processing method for causing a display unit to display a body based on position data of the body in a three-dimensional space, including the steps of setting a reference point in the proximity of the body in the three-dimensional space displayed on the display unit, and producing a straight line in the three-dimensional space which passes the reference point and controlling the display unit to display the straight line together with the body.

Preferably, the three-dimensional model processing method further includes the step of producing an intersecting line between a plane in the three-dimensional space which includes the reference point and the display object body and controlling the display unit to display the intersecting line together with the body.

The three-dimensional model processing method may further include the step of controlling the display unit to display a plane in the three-dimensional space which includes the reference point.

Preferably, the straight line which passes the reference point is a straight line parallel to a straight line which is produced, where a display plane of the display unit is an XY plane and a direction perpendicular to the display plane is a Z-axis, by rotating the Z-axis by an angle of α degrees around the X-axis where −90<α<90 and α≠0.

Preferably, the plane which includes the reference point is a plane parallel to a plane which is produced, where a display plane of the display unit is an XY plane and a direction perpendicular to the display plane is a Z-axis, by rotating the XZ plane by an angle of α degrees around the X-axis where −90<α<90 and α≠0.

The plane which includes the reference point may be a plane which is, where a display plane of the display unit is an XY plane and a direction perpendicular to the display plane is a Z-axis, a plane parallel to the YZ plane.

Preferably, the three-dimensional model processing method further includes the step of producing a number of intersecting lines between a number of planes in the three-dimensional space which include the reference point and the display object body and controlling the display unit to display the intersecting lines together with the body.

Graduations may be indicated in a spaced relationship by a predetermined distance from each other on the straight line.

Grating lines may be indicated in a spaced relationship by a predetermined distance from each other on the plane.

Preferably, the three-dimensional model processing method further includes the step of controlling the display unit to display a plane, which is parallel to a plane produced, where a display plane of the display unit is an XY plane and a direction perpendicular to the display plane is a Z-axis, by rotating the XZ plane by an angle of α degrees around the X-axis where −90<α<90 and α≠0, at a position at which the plane does not intersect with the body and display a projection image of the body, the reference point and the straight line on the plane.

With the three-dimensional model processing apparatus and the three-dimensional model processing method, on a body displayed on the display unit, a reference point, a straight line extending from the reference point and an intersecting line which is formed on the body with a plane which includes the reference point are displayed together with the body. Consequently, a three-dimensional position of the body can be recognized readily.

According to yet another embodiment of the present invention, there is provided a three-dimensional modeling apparatus, including a display unit for displaying a processing object body and a processing tool, a data inputting section for relatively moving a processing object body sensor and a processing tool sensor which correspond to the processing object body and the processing tool, respectively, in an operation area in which three-dimensional positions of the sensors can be acquired to produce three-dimensional position data in accordance with variations of the relative positions of the processing object body sensor and the processing tool sensor, and a display control part for updating a displaying manner of the processing object body and the processing tool displayed on the display unit based on the three-dimensional position data of the sensors from the data inputting section, setting a reference point in the proximity of the processing object body in the three-dimensional space displayed on the display unit, producing a straight line in the three-dimensional space which passes the reference point and controlling the display unit to display the straight line together with the body.

Preferably, the display control part further produces an intersecting line between a plane in the three-dimensional space which includes the reference point and the display object body and controls the display unit to display the intersecting line together with the body.

The display control part may further control the display unit to display a plane in the three-dimensional space which includes the reference point.

Preferably, the straight line which passes the reference point is a straight line parallel to a straight line which is produced, where a display plane of the display unit is an XY plane and a direction perpendicular to the display plane is a Z-axis, by rotating the Z-axis by an angle of α degrees around the X-axis where −90<α<90 and α≠0.

Preferably, the plane which includes the reference point is a plane parallel to a plane which is produced, where a display plane of the display unit is an XY plane and a direction perpendicular to the display plane is a Z-axis, by rotating the XZ plane by an angle of α degrees around the X-axis where −90<α<90 and α≠0.

The plane which includes the reference point may be a plane which is, where a display plane of the display unit is an XY plane and a direction perpendicular to the display plane is a Z-axis, a plane parallel to the YZ plane.

Preferably, the display control part further produces a number of intersecting lines between a number of planes in the three-dimensional space which include the reference point and the display object body and controls the display unit to display the intersecting lines together with the body.

Graduations may be indicated in a spaced relationship by a predetermined distance from each other on the straight line.

Grating lines may be indicated in a spaced relationship by a predetermined distance from each other on the plane.

Preferably, the display control part controls the display unit to display a plane, which is parallel to a plane produced, where a display plane of the display unit is an XY plane and a direction perpendicular to the display plane is a Z-axis, by rotating the XZ plane by an angle of α degrees around the X-axis where −90<α<90 and α≠0, at a position at which the plane does not intersect with the body and display a projection image of the body, the reference point and the straight line on the plane.

With the three-dimensional modeling apparatus, on the display unit on which a processing object body and a processing tool are displayed, a reference point, a straight line extending from the reference point and an intersecting line which is formed on the body with a plane which includes the reference point are displayed together with the processing object body. Consequently, the operator can recognize a positional relationship between the tool and the processing object body readily and, therefore, can execute various processes readily and accurately.

According to still another embodiment of the present invention, there is provided a program providing medium for providing a computer program which causes a computer system to execute a three-dimensional modeling process of causing a display unit to display a body based on position data of the body in a three-dimensional space, the computer program including the steps of setting a reference point in the proximity of the body in the three-dimensional space displayed on the display unit, and producing a straight line in the three-dimensional space which passes the reference point and controlling the display unit to display the straight line together with the body.

The program providing medium provides the computer program in a computer-readable form, for example, to a computer system for universal use which can execute various programs and codes. The medium is not restricted specifically in terms of the form and may be a storage medium such as a compact disc (CD), a floppy disk (FD) or a magneto-optical disk (MO) or a transmission medium such as a network.

Such a program providing medium as described above defines a cooperative relationship in structure or function between a computer program and the providing medium for realizing a function of a predetermined computer program on a computer system. In other words, by installing the computer program from the providing medium into the computer system, a cooperative operation is exhibited on the computer system. Consequently, the advantages provided by the three-dimensional model processing apparatus and method and the three-dimensional modeling apparatus described above can be anticipated.

The above and other embodiments, features and advantages of the present invention will become apparent from the following Detailed Description of the Preferred Embodiments and the appended claims, taken in conjunction with the accompanying Drawings in which like parts or elements are denoted by like reference numerals.

### DESCRIPTION OF THE DRAWINGS

FIGS. 1a and 1b are schematic views illustrating an outline of a processing construction of a three-dimensional model processing apparatus of the present invention;

FIG. 2 is a block diagram showing a construction of a three-dimensional model processing apparatus to which the present invention is applied;

FIG. 3 is a flow chart illustrating operation of the three-dimensional model processing apparatus of FIG. 2;

FIGS. 4 to 9 are schematic diagrammatic views illustrating different processing manners of the three-dimensional model processing apparatus of FIG. 2;

FIG. 10 is a schematic view showing a processing manner of a three-dimensional modeling apparatus to which the present invention is applied;

FIG. 11 is a block diagram showing a construction of the three-dimensional modeling apparatus of FIG. 10; and

FIG. 12 is a flow chart illustrating operation of the three-dimensional modeling apparatus of FIG. 10.

### DETAILED DESCRIPTION OF THE PREFERRED EMBODIMENTS

### Three-Dimensional Model Processing Apparatus

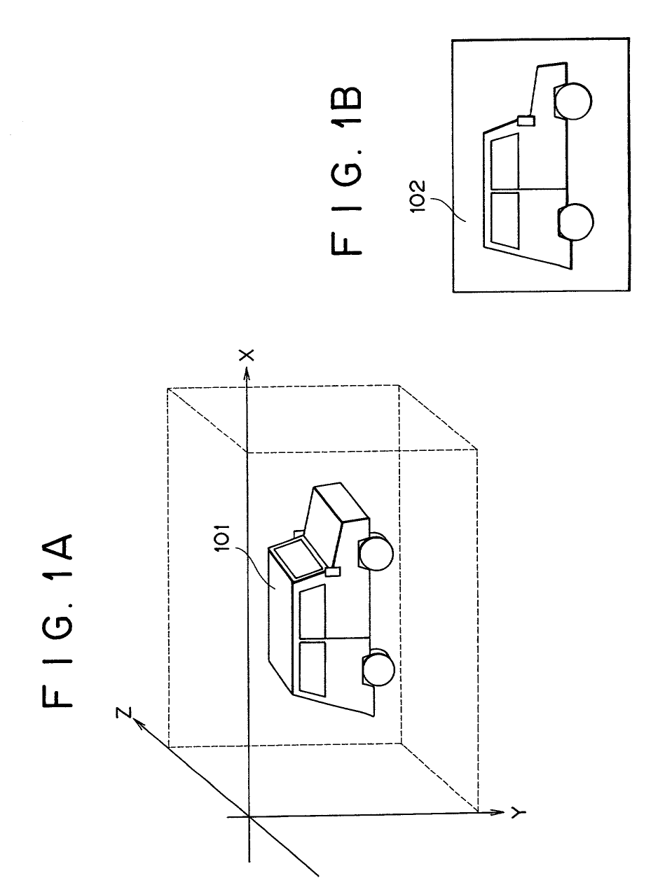

First, an outline of a display process executed by a three-dimensional model processing apparatus of the present invention is described with reference to. FIGS. 1a and 1b. FIG. 1a shows a display body 101 in a three-dimensional space. In FIG. 1a, the plane defined by the X- and Y-axes corresponds to a display plane 102. The Z-axis corresponds to the depthwise direction. A display screen for the display body 101 as viewed from a certain visual point exhibits such a display as shown in FIG. 1b. It is to be noted that the direction of the eye in FIG. 1b is parallel to the Z-axis. In the three-dimensional model processing apparatus of the present invention, in order to allow such a position of the display body 101 in the depthwise (Z-axis) direction to be visually recognized, a process of displaying an auxiliary line or an auxiliary plane on the display screen is executed.

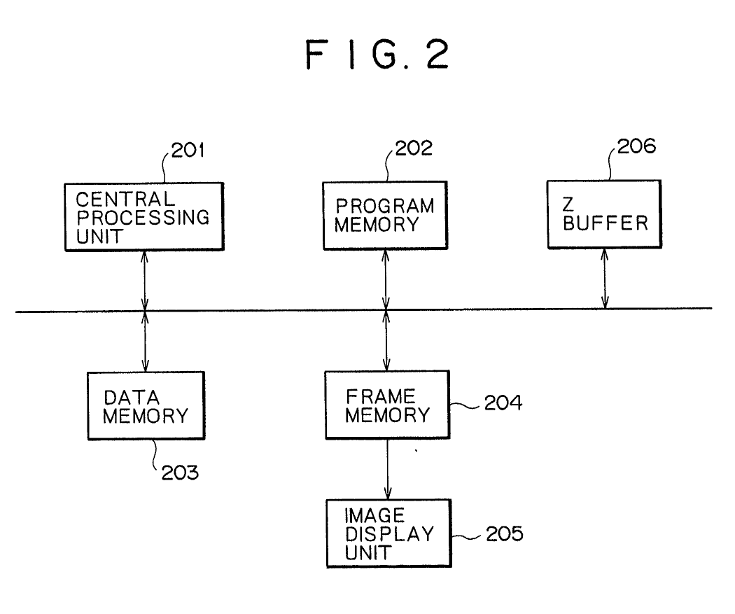

FIG. 2 shows a system construction of a display control apparatus and a display unit which form a three-dimensional model processing apparatus to which the present invention is applied. Referring to FIG. 2, the three-dimensional model processing apparatus according to the present invention includes a central processing unit (CPU) 201, a program memory 202, a data memory 203, a frame memory 204, an image display unit 205, and a Z buffer 206.

Processing data is stored in the data memory 203, and the central processing unit (CPU) 201 extracts the processing data from the data memory 203 and executes a projection conversion process and a display data production process with the processing data in accordance with a process program stored in the program memory 202. The display data thus produced is stored into the frame memory 204. The image display unit 205 displays the display data stored in the frame memory 204. The Z buffer 206 is a memory for allowing an invisible face process to be performed and stores values (Z values) of all pixels of the display screen in the depthwise directions. By referring to the values stored in the Z buffer 206, it is possible to acquire depthwise relation data from a visual point regarding a number of bodies present in different positions in a three-dimensional space and display the bodies correctly irrespective of a plotting order of the bodies.

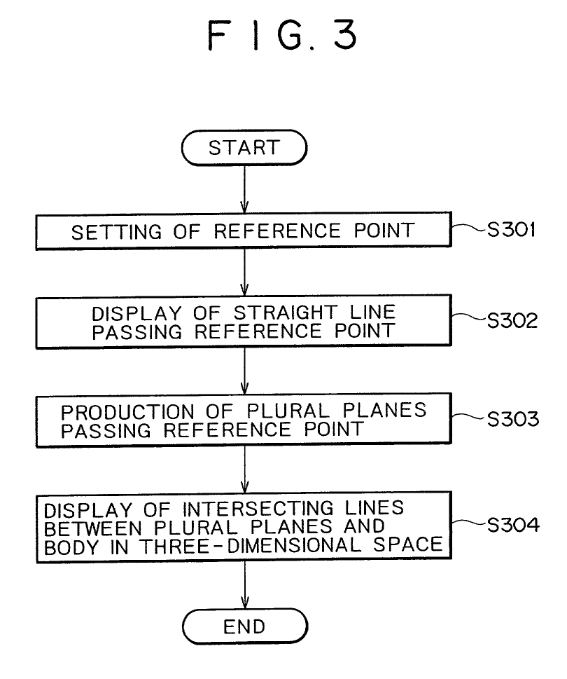

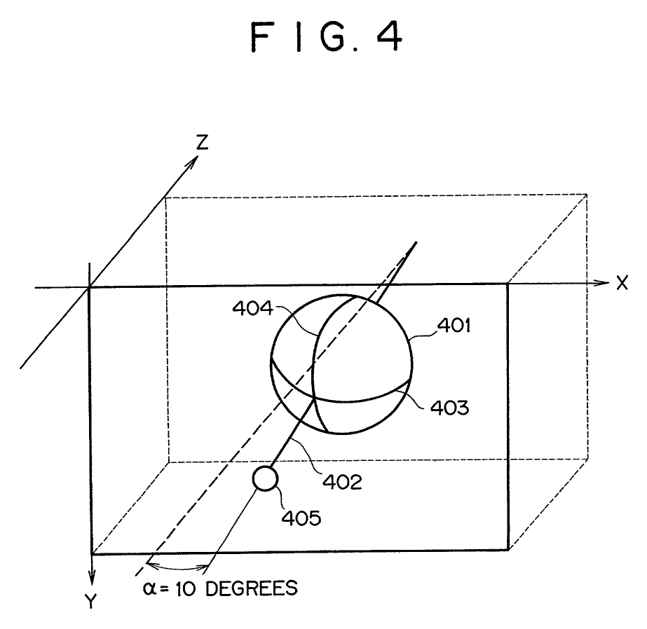

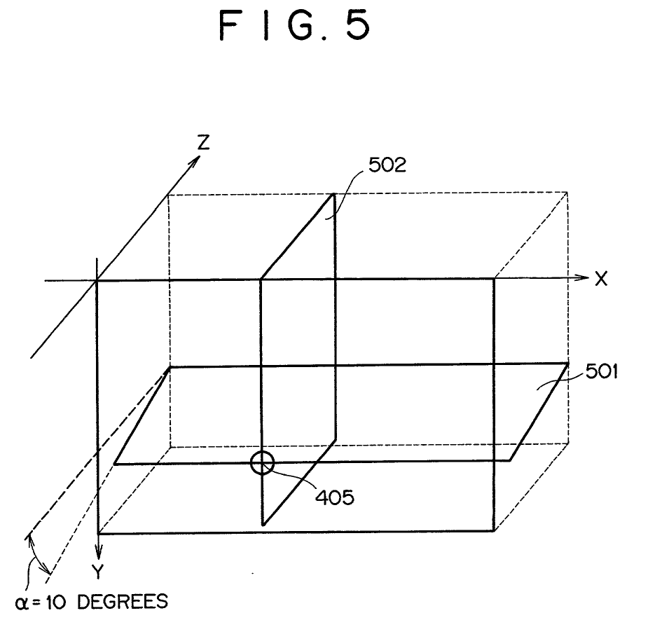

Operation of the three-dimensional model processing apparatus is described with reference to a flow chart of FIG. 3 and display examples of FIGS. 4 and 5. FIG. 4 shows a body 401 displayed on the display unit, and a straight line 402 and a pair of intersecting lines 403 and 404 as auxiliary lines for allowing the depthwise direction to be recognized readily and a reference point 405 serving as a start point of the straight line 402. It is to be noted that the Z-axis direction corresponds to the depthwise direction.

Details of the operation of the three-dimensional model processing apparatus are described with reference to FIG. 3. First, a reference point is set on a three-dimensional space in step S301. The reference point may be selected arbitrarily, but is preferably set to a position in the proximity of and forwardly of (nearer to the visual point from) a display body. In FIG. 4, the reference point 405 is set to a position obliquely forwardly of the body 401.

Then in step S302, a straight line which passes the reference point 405 and extends in parallel to a straight line formed when the Z-axis is rotated by an angle α around the X-axis. The angle α which is an angle of rotation of the Z-axis can be set to an arbitrary angle which satisfies −90<α<90 and α≠0, but is preferably set so that an intersecting line formed on the body 401 by a plane produced based on the angle α may be comparatively long. The plane and the intersecting line are described below in connection with step S303. It is assumed here that the angle α is set to α=10 degrees.

Where the angle α is set to α=10 degrees, in step S302, the straight line 402 obtained by rotating the straight line parallel to the Z-axis by 10 degrees around the X-axis is displayed as indicated by a thick broken line in FIG. 4. In this instance, the straight line 402 is displayed such that the depthwise relationship of the straight line 402 and the body 401 may be correct making use of values of the Z buffer 206 described hereinabove with reference to FIG. 2. In particular, a portion of the straight line 402 which is positioned forwardly of (nearer than) the body 401 is displayed entirely, but another portion of the straight line 402 which overlaps with the body 401 and is positioned rearwardly of (farther than) the body 401 is not displayed, and a further portion of the straight line 402 which is positioned rearwardly of the body 401 but does not overlap with the body 401 is displayed. As a result, such a display manner as seen in FIG. 4 is obtained.

As can be recognized from FIG. 4, the reference point 405 and the body 401 are displayed connected to each other by the straight line 402, and the spaced condition between the body 401 and the reference point 405 in the depthwise direction can be recognized based on the length of the segment of the straight line displayed forwardly of the body 401.

Then in step S303, a plane (denoted by 501 in FIG. 5) parallel to a plane which includes the straight line 402 and is produced by rotating the XZ plane by α degrees around the X-axis and another plane 502 which includes the straight line 402 and extends in parallel to the YZ plane are produced. Further, intersecting lines between the two planes and the body 401 are displayed. The intersecting lines here are the intersecting lines 403 and 404 shown in FIG. 4. The display of the intersecting lines allows recognition of by what distances the body 401 is spaced from the reference point 405 in the vertical direction and the horizontal direction.

The display of the straight line 402 extending from the reference point 405 to the body 401 and the intersecting lines 403 and 404 together with the body 401 in this manner allows easy recognition of the three-dimensional position of the body 401 with respect to the reference point. While the display example of FIG. 4 includes a single body, even where a number of bodies are involved, a display of a straight line passing a reference point and intersecting lines allows easy recognition of the relationship in three-dimensional position between the number of bodies. In this instance, preferably the display positions of the straight line and the intersecting lines are selected so that they pass the number of bodies. Alternatively, straight lines and intersecting lines may be produced while setting one of bodies itself as a reference point.

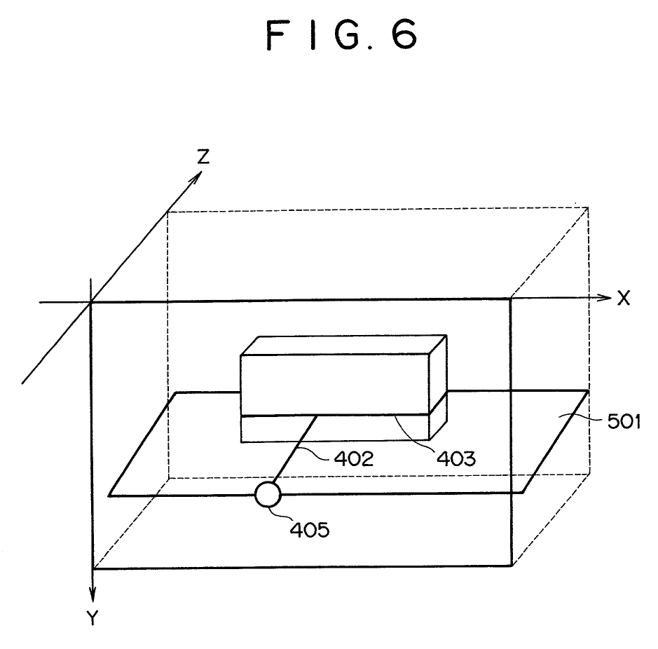

In the display example shown in FIG. 4, the body 401 which passes the straight line 402 and the intersecting lines formed on the body 401 with the plane produced in step S303 of FIG. 3 are displayed. However, for example, a plane 501 which passes the reference point 405 may be displayed in addition to an intersecting line 403 with the body 401 as seen in FIG. 6. In FIG. 6, the plane 501 which includes the straight line 402 and extends in parallel to a plane produced when the XZ plane is rotated by the angle α around the X-axis is displayed. Further, a plane 502 (refer to FIG. 5) which extends in parallel to the YZ plane may be displayed additionally. Where a plane is displayed in color or displayed transparently or translucently on the display unit to facilitate distinction of displayed bodies, recognition of the positional relationship of the bodies is further facilitated.

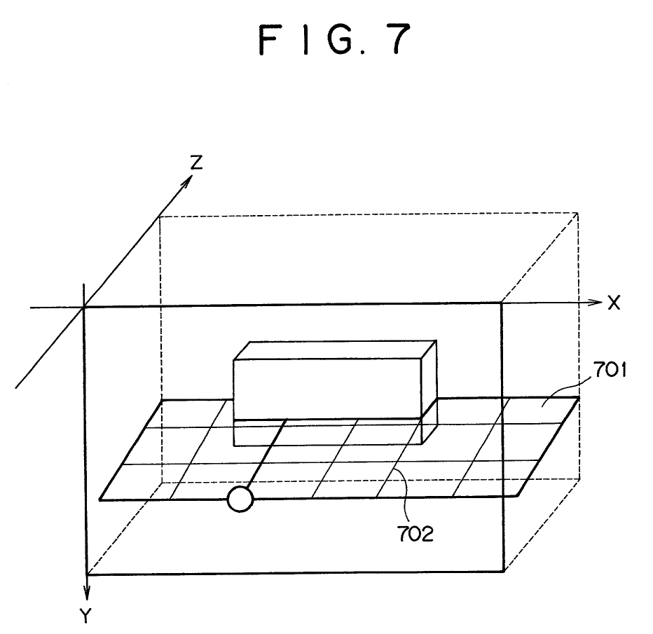

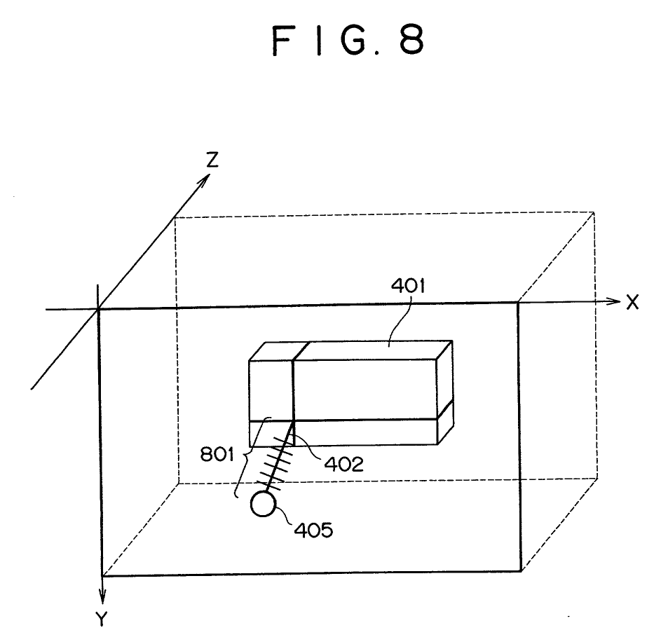

Further, where grating lines 702 are displayed in a spaced relationship by a fixed distance from each other on a display plane 701 as seen in FIG. 7, a horizontal magnitude or distance and a depthwise magnitude or distance can be recognized further readily by an observer. On the other hand, if graduations 801 are displayed on the straight line 402 extending from the reference point 405 as seen in FIG. 8, the distance between the reference point 405 and the body 401 can be recognized readily.

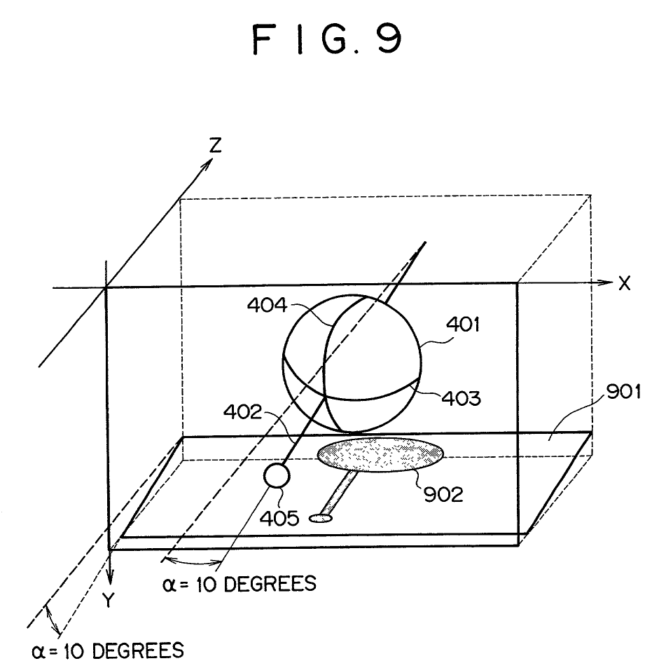

Furthermore, where, as shown in FIG. 9, a plane 901 produced by rotating the XZ plane by α degrees around the X-axis is displayed at a position at which it does not intersect with the body 401 such as, for example, at a position below the body 401 and the body 401, reference point 405 and straight line 402 are projected parallelly on the plane 901 so as to display a shadow 902 of the body 401, reference point 405 and straight line 402, the positional relationship of the body can be recognized with reality.

### Three-Dimensional Modeling Apparatus

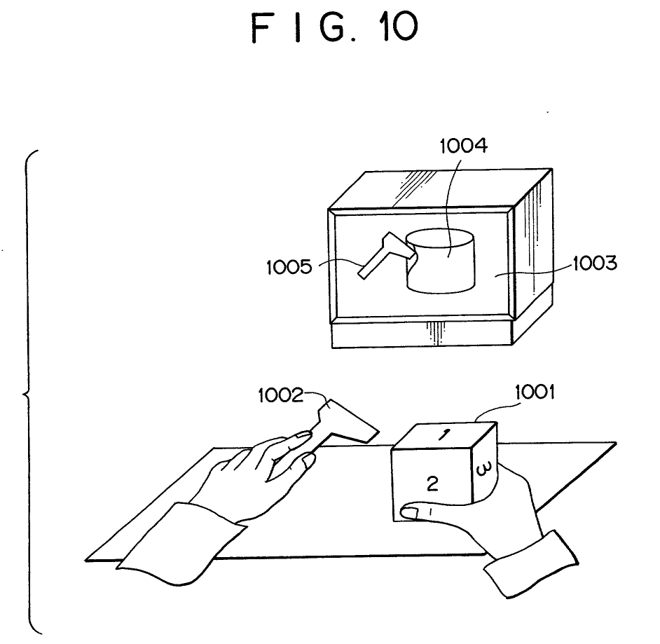

Subsequently, a three-dimensional modeling system to which the displaying scheme described above is applied is described. For example, such a three-dimensional modeling system as shown in FIG. 10 is constructed. In the three-dimensional modeling system shown in FIG. 10, two three-dimensional position and angle sensors 1001 and 1002 are moved relative to each other in an operation area by a user to vary the relative positions and the relative angles of them, and various processes are executed for a processing object body 1004 displayed on a display unit 1003 and corresponding to the three-dimensional position and angle sensor 1001 using a processing tool 1005 corresponding to the three-dimensional position and angle sensor 1002 to execute various operations such as deformation and coloring for the processing object body 1004.

Three-dimensional positions of the two three-dimensional position and angle sensors 1001 and 1002 are acquired from magnetic sensors or like sensors, and processing functions such as deformation and coloring are set in advance for the three-dimensional position and angle sensor 1002 corresponding to the processing tool 1005. For example, if the three-dimensional position and angle sensor 1002 is moved toward the three-dimensional position and angle sensor 1001 corresponding to the processing object body 1004 until the distance between them becomes smaller than a fixed distance, then processing is executed such that, for example, the processing tool 1005 displayed on the display unit 1003 moves into the inside of the processing object body 1004 and forms a recess in the processing object body 1004.

As seen in FIG. 10, the processing object body 1004 and the processing tool 1005 which correspond to the three-dimensional position and angle sensors 1001 and 1002, respectively, are displayed on the display unit 1003. However, the positional relationship between the processing object body 1004 and the processing tool 1005 may not be recognized at a glance by an operator. Where such a reference point 405, a straight line 402 extending from the reference point 405, intersecting lines 403 and 404 defined by planes, the planes 501 and 502 and so forth as described hereinabove with reference to FIGS. 4 and 5 are displayed on the display of such a system as shown in FIG. 10, the positional relationship of the processing object body 1004 and the processing tool 1005 can be recognized at a glance, which facilitates processing by the operator.

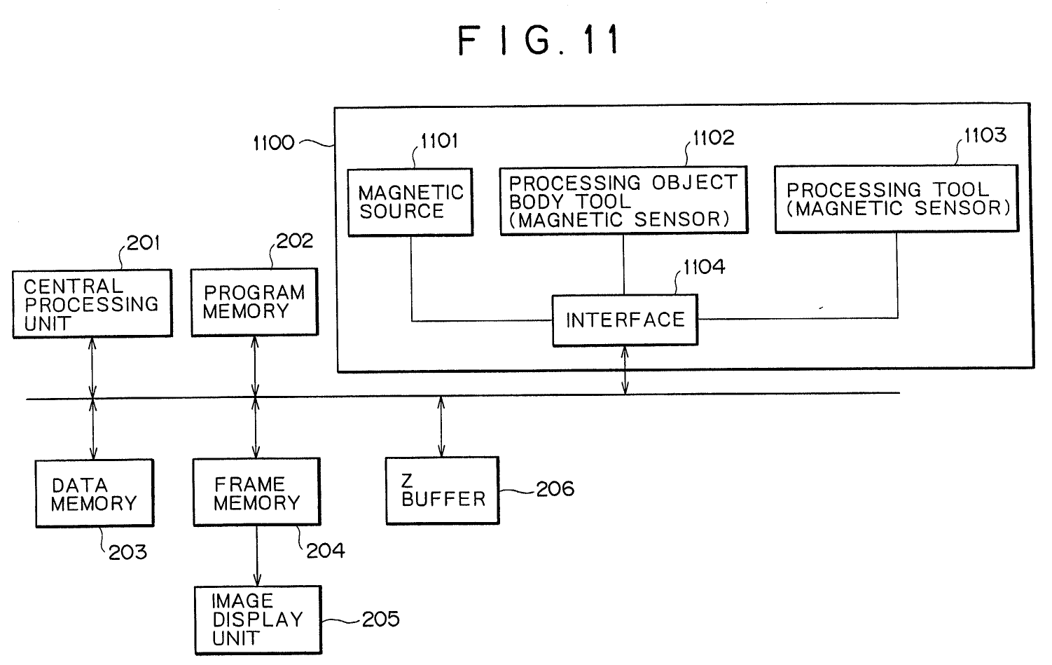

It is to be noted that, if the reference point is not set as a fixed point but, for example, the processing tool 1005 displayed on the display unit 1003 of FIG. 10 is set as a reference point such that also the reference point is displayed on the display unit 1003 so as to move when the processing tool 1005 moves, then recognition by the operator of the position of the processing object body from the tool which corresponds to the reference point is further facilitated. A construction of such a three-dimensional modeling system as described above is shown in FIG. 11.

In particular, FIG. 11 shows a three-dimensional modeling system which includes a data inputting section 1100 to which data is inputted from sensors in addition to the three-dimensional model processing apparatus described hereinabove with reference to FIG. 2. The three-dimensional modeling system uses a magnetic sensor as a three-dimensional position-angle sensor. Referring to FIG. 11, a processing object body tool 1102 and a processing tool 1103 operate in an operation area formed in a magnetic field generated from a magnetic source 1101. A magnetic sensor is mounted on each of the processing object body tool 1102 and the processing tool 1103, and the magnetic sensors of the processing object body tool 1102 and the processing tool 1103 output magnetic displacement data to an interface 1104 for exclusive use within the operation area set within the magnetic field generated from the magnetic source 1101. The interface 1104 for exclusive use calculates position information and posture information data of the processing object body tool 1102 and the processing tool 1103 based on the received magnetic displacement data.

Based on the position information and the posture information data inputted from the data inputting section 1100 in this manner, the central processing unit (CPU) 201 of the three-dimensional processing system executes a projection conversion process and a display data production process in accordance with a processing program stored in the program memory 202. The display data produced are stored into the frame memory 204. Further, the image display unit 205 displays the display data stored in the frame memory 204.

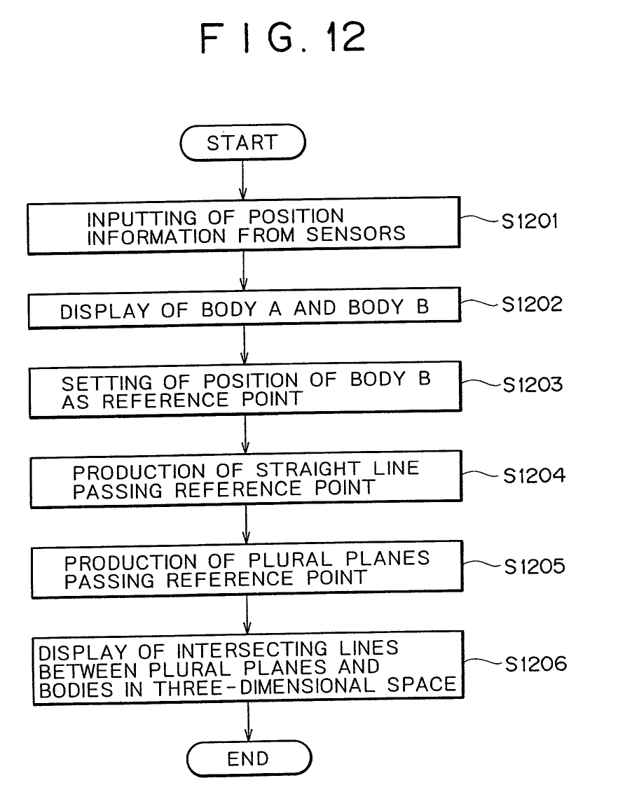

A display process of the three-dimensional modeling system shown in FIG. 11 is described with reference to a flow chart of FIG. 12. First in step S 1201, position information from the sensors (in the system shown in FIG. 10, the three-dimensional position and angle sensors 1001 and 1002) is inputted to the three-dimensional modeling system. Then in step S1202, a body and a processing tool associated with the sensor corresponding to the processing object body and the sensor corresponding to the processing tool, respectively, are displayed on the image display unit 205.

Then in step S1203, the processing tool displayed on the image display unit 205 is set as a reference point. Then, processing similar to that described hereinabove in connection with steps S301, S302 and S303 of FIG. 3 is executed in steps S1204, S1205 and S1206, respectively. In particular, a series of processes of production of a straight line passing the reference point (step S1204), production of a number of planes passing the reference point (step S 1205) and displaying of intersecting lines between the produced planes and the processing object body (step S1206) are executed.

As a result of the processing described, a display similar to that of FIG. 4 described above is obtained. The body 401 shown in FIG. 4 corresponds to the processing object body and the reference point 405 corresponds to the processing tool. It is to be noted that, since the positions of the processing tool and the processing object body are changed at any time in response to movements of the sensors by the operator and data of the new positions and the angles are inputted from the data inputting section 1100, the processing of the flow chart of FIG. 12 is executed based on the input data to update the display.

With the three-dimensional modeling apparatus described above, since a tool corresponding to a sensor used by an operator is indicated as a reference point on a display unit and a straight line and intersecting lines which clearly indicate a three-dimensional positional relationship between the position of the reference point and a processing object body are displayed, processing by the operator can be executed readily and accurately. It is to be noted that, also in the three-dimensional modeling apparatus, a plane which passes the reference point (tool) may be displayed additionally as described hereinabove with reference to FIG. 6. Further, if grating lines 702 are displayed in a spaced relationship by a fixed distance from each other on a display plane 701 as seen in FIG. 7, or if graduations 801 are displayed on the straight line 402 extending from the reference point 405 as seen in FIG. 8, or else if, as shown in FIG. 9, a plane 901 produced by rotating the XZ plane by α degrees around the X-axis is displayed at a position below the processing object body and the processing object body, the reference point (tool) and the straight line are projected parallelly on the plane so as to display a shadow of them, the positional relationship of the body is further facilitated.

Although the present invention has been described with reference to specific embodiments, those of skill in the art will recognize that changes may be made thereto without departing from the spirit and scope of the invention as set forth in the hereafter appended claims.

We claim as our invention:

1. A three-dimensional model processing apparatus for causing a display unit to display a body based on position data of the body in a three-dimensional space, comprising:
a setting part for setting a reference point in proximity of the body in the three-dimensional space displayed on the display unit; and
a display control part for producing a first straight line in the three-dimensional space which passes the reference point and for controlling the display unit to display the first straight line together with the body.

2. A three-dimensional model processing apparatus as claimed in claim 1, wherein the display control part further produces an intersecting line between a first plane in the three-dimensional space which includes the reference point and the body and controls the display unit to display the intersecting line together with the body.

3. A three-dimensional model processing apparatus as claimed in claim 1, wherein the display control part further controls the display unit to display a first plane in the three-dimensional space which includes the reference point.

4. A three-dimensional model processing apparatus as claimed in claim 1, wherein the first straight line which passes the reference point is parallel to a second straight line which is produced, where a display plane of the display unit is an XY plane and a direction perpendicular to the display plane is a Z-axis, by rotating the Z-axis by an angle of α degrees around the X-axis where −90<α<90 and α≠0.

5. A three-dimensional model processing apparatus as claimed in claim 2, wherein the first plane which includes the reference point is parallel to a second plane which is produced, where a display plane of the display unit is an XY plane and a direction perpendicular to the display plane is a Z-axis, by rotating the XZ plane by an angle of α degrees around the X-axis where −90<α<90 and α≠0.

6. A three-dimensional model processing apparatus as claimed in claim 2, wherein the first plane which includes the reference point parallel to the YZ plane, where a display plane of the display unit is an XY plane and a direction perpendicular to the display plane is a Z-axis.

7. A three-dimensional model processing apparatus as claimed in claim 1, wherein the display control part further produces a plurality of intersecting lines between a plurality of planes in the three-dimensional space which include the reference point and the body and controls the display unit to display the intersecting lines together with the body.

8. A three-dimensional model processing apparatus as claimed in claim 1, wherein graduations are indicated in a spaced relationship by a predetermined distance from each other on the first straight line.

9. A three-dimensional model processing apparatus as claimed in claim 3, wherein grating lines are indicated in a spaced relationship by a predetermined distance from each other on the first plane.

10. A three-dimensional model processing apparatus as claimed in claim 1, wherein the display control part controls the display unit to display a first plane, which is parallel to a second plane produced, where a display plane of the display unit is an XY plane and a direction perpendicular to the display plane is a Z-axis, by rotating the XZ plane by an angle of α degrees around the X-axis where −90 <α<90 and α≠0, at a position at which the second plane does not intersect with the body and display a projection image of the body, the reference point and the first straight line on the second plane.

11. A three-dimensional model processing method for causing a display unit to display a body based on position data of the body in a three-dimensional space, the method comprising the steps of:
setting a reference point in proximity of the body in the three-dimensional space displayed on the display unit; and
producing a first straight line in the three-dimensional space which passes the reference point and controlling the display unit to display the first straight line together with the body.

12. A three-dimensional model processing method as claimed in claim 11, further comprising the step of:
producing an intersecting line between a first plane in the three-dimensional space which includes the reference point and the body and controlling the display unit to display the intersecting line together with the body.

13. A three-dimensional model processing method as claimed in claim 11, further comprising the step of:
controlling the display unit to display a first plane in the three-dimensional space which includes the reference point.

14. A three-dimensional model processing method as claimed in claim 11, wherein the first straight line which passes the reference point is parallel to a second straight line which is produced, where a display plane of the display unit is an XY plane and a direction perpendicular to the display plane is a Z-axis, by rotating the Z-axis by an angle of α degrees around the X-axis where −90<α<90 and α≠0.

15. A three-dimensional model processing method as claimed in claim 12, wherein the first plane which includes the reference point is parallel to a second plane which is produced, where a display plane of the display unit is an XY plane and a direction perpendicular to the display plane is a Z-axis, by rotating the XZ plane by an angle of α degrees around the X-axis where −90<α<90 and α≠0.

16. A three-dimensional model processing method as claimed in claim 12, wherein the first plane which includes the reference point is parallel to the YZ plane, where a display plane of the display unit is an XY plane and a direction perpendicular to the display plane is a Z-axis.

17. A three-dimensional model processing method as claimed in claim 11, further comprising the step of:
producing a plurality of intersecting lines between a plurality of planes in the three-dimensional space which include the reference point and the body and controlling the display unit to display the intersecting lines together with the body.

18. A three-dimensional model processing method as claimed in claim 11, wherein graduations are indicated in a spaced relationship by a predetermined distance from each other on the first straight line.

19. A three-dimensional model processing method as claimed in claim 13, wherein grating lines are indicated in a spaced relationship by a predetermined distance from each other on the first plane.

20. A three-dimensional model processing method as claimed in claim 11, further comprising the step of:
controlling the display unit to display a first plane, which is parallel to a second plane produced, where a display plane of the display unit is an XY plane and a direction perpendicular to the display plane is a Z-axis, by rotating the XZ plane by an angle of α degrees around the X-axis where −90<α<90 and α≠0, at a position at which the second plane does not intersect with the body and display a projection image of the body, the reference point and the first straight line on the second plane.

21. A three-dimensional modeling apparatus, comprising:
a display unit for displaying a processing object body and a processing tool;
a data inputting section for moving a processing object body sensor and a processing tool sensor, relative to one another, which correspond to the processing object body and the processing tool, respectively, in an operation area in which three-dimensional positions of both the processing object body sensor and the processing tool sensor can be acquired to produce three-dimensional position data in accordance with variations of the relative positions of the processing object body sensor and the processing tool sensor; and
a display control part for updating a displaying manner of the processing object body and the processing tool displayed on the display unit based on the three-dimensional position data of both the processing object body sensor and the processing tool sensor from the data inputting section, for setting a reference point in proximity of the processing object body in the three-dimensional space displayed on the display unit, for producing a first straight line in the three-dimensional space which passes the reference point and for controlling the display unit to display the first straight line together with the body.

22. A three-dimensional modeling apparatus as claimed in claim 21, wherein the display control section further produces an intersecting line between a first plane in the three-dimensional space which includes the reference point and the body and controls the display unit to display the intersecting line together with the body.

23. A three-dimensional modeling apparatus as claimed in claim 21, wherein the display control section further controls the display unit to display a first plane in the three-dimensional space which includes the reference point.

24. A three-dimensional modeling apparatus as claimed in claim 21, wherein the first straight line which passes the reference point is parallel to a second straight line which is produced, where a display plane of the display unit is an XY plane and a direction perpendicular to the display plane is a Z-axis, by rotating the Z-axis by an angle of α degrees around the X-axis where −90<α<90 and α≠0.

25. A three-dimensional modeling apparatus as claimed in claim 22, wherein the first plane which passes the reference point is parallel to a second plane which is produced, where a display plane of the display unit is an XY plane and a direction perpendicular to the display plane is a Z-axis, by rotating the XZ plane by an angle of α degrees around the X-axis where −90<α<90 and α≠0.

26. A three-dimensional modeling apparatus as claimed in claim 22, wherein the first plane which includes the reference point is parallel to the YZ plane, where a display plane of the display unit is an XY plane and a direction perpendicular to the display plane is a Z-axis.

27. A three-dimensional modeling apparatus as claimed in claim 21, wherein the display control section further produces a plurality of intersecting lines between a plurality of planes in the three-dimensional space which include the reference point and the body and controls the display unit to display the intersecting lines together with the body.

28. A three-dimensional modeling apparatus as claimed in claim 21, wherein graduations are indicated in a spaced relationship by a predetermined distance from each other on the first straight line.

29. A three-dimensional modeling apparatus as claimed in claim 23, wherein grating lines are indicated in a spaced relationship by a predetermined distance from each other on the first plane.

30. A three-dimensional modeling apparatus as claimed in claim 21, wherein the display control section controls the display unit to display a first plane, which is parallel to a second plane produced, where a display plane of the display unit is an XY plane and a direction perpendicular to the display plane is a Z-axis, by rotating the XZ plane by an angle of α degrees around the X-axis where −90<α<90 and α≠0, at a position at which the second plane does not intersect with the body and display a projection image of the body, the reference point and the first straight line on the second plane.

31. A medium for providing a computer program which causes a computer system to execute a three-dimensional modeling process enabling a display unit to display a body based on position data of the body in a three-dimensional space, the computer program comprising the steps of:
setting a reference point in proximity of the body in the three-dimensional space displayed on the display unit; and
producing a straight line in the three-dimensional space which passes the reference point and controlling the display unit to display the straight line together with the body.
